(19) United States
(12) Patent Application Publication
(10) Pub. No.: US 2025/0023275 A1
(43) Pub. Date: Jan. 16, 2025

(54) TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shingo KOBAYASHI, Mie (JP)

(21) Appl. No.: 18/712,123

(22) PCT Filed: Nov. 16, 2022
(86) PCT No.: PCT/JP2022/042612

§ 371 Date: May 21, 2024

(30) Foreign Application Priority Data
Dec. 6, 2021 (JP) 2021-197660

(51) Int. Cl. H01R 13/187

(52) U.S. Cl. CPC H01R 13/187

(57) ABSTRACT

A terminal includes a case including a first wall, a second wall and coupling walls, a first spring member including a first resilient piece and mounted on the first wall, a second spring member including a second resilient piece and mounted on the second wall, a plate-like first conductor thicker than the first resilient piece and having a longitudinal direction along the first direction, and a plate-like second conductor thicker than the second resilient piece and having a longitudinal direction along the first direction. The first conductor includes a first connecting portion on one side in the longitudinal direction to be connected to another member and a first plate portion on the other side in the longitudinal direction. The second conductor includes a second connecting portion on one side to be connected to the other member and a second plate portion on the other side.

### TECHNICAL FIELD

The present disclosure relates to a terminal.

This application is based on Japanese Patent Application No. 2021-197660 filed with the Japan Patent Office on Dec. 6, 2021, the contents of which are hereby incorporated by reference.

### BACKGROUND

To connect two electrical devices, a connector of each electrical device is provided with a terminal. A terminal including a tubular case, into which a mating conductor is inserted, and a resilient contact piece provided in the case (disclosed, for example, in Patent Document 1) is known as such a terminal. The resilient contact piece presses the mating conductor inserted into the case toward an inner wall of the case.

### PRIOR ART DOCUMENT

### Patent Document

Patent Document 1: JP 2020-202092 A

### SUMMARY OF THE INVENTION

A terminal according to one aspect of the present disclosure is to be connected to a plate-like mating conductor inserted along a first direction, and provided with a case including a first wall located on one side in an orthogonal direction to the first direction, a second wall located on the other side in the orthogonal direction and coupling walls coupling the first and second walls, a first spring member including a first resilient piece, the first spring member being mounted on the first wall, a second spring member including a second resilient piece, the second spring member being mounted on the second wall, a plate-like first conductor thicker than the first resilient piece, the first conductor having a longitudinal direction along the first direction, and a plate-like second conductor thicker than the second resilient piece, the second conductor having a longitudinal direction along the first direction, the first conductor including a first connecting portion on one side in the longitudinal direction to be connected to another member and a first plate portion on the other side in the longitudinal direction, the second conductor including a second connecting portion on one side in the longitudinal direction to be connected to the other member and a second plate portion on the other side in the longitudinal direction, the first resilient piece biasing the first plate portion in a direction toward the second plate portion, the second resilient piece biasing the second plate portion in a direction toward the first plate portion, and a space between the first and second plate portions being a region where the mating conductor inserted along the first direction is sandwiched.

### BRIEF DESCRIPTION OF THE DRAWINGS

FIG. 1 is a perspective view of a terminal (in a non-connected state) of an embodiment.

FIG. 2 is a perspective view of the terminal (in a connected state) of the embodiment.

FIG. 3 is an exploded perspective view of the terminal shown in FIG. 1.

FIG. 4 is a view showing an internal structure of the terminal.

FIG. 5 is a perspective view of a terminal conductor configured by integrating a first conductor and a second conductor.

FIG. 6 is a section of the terminal (in the non-connected state).

FIG. 7 is a section of the terminal (in the connected state).

FIG. 8 is a view of a first spring member and a second spring member.

FIG. 9 is a section of the terminal when viewed along a sandwiching direction.

FIG. 10 is a section showing a schematic configuration of a conventional terminal.

FIG. 11 is a section showing a schematic configuration of another conventional terminal.

### DETAILED DESCRIPTION TO EXECUTE THE INVENTION

### Technical Problem

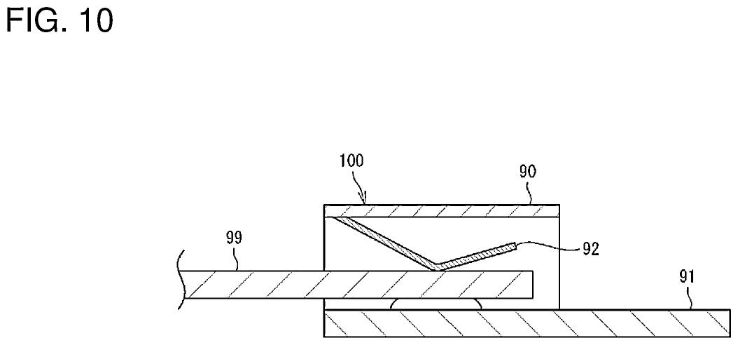

FIG. 10 is a section showing a schematic configuration of a conventional terminal. This terminal 100 is of a one-sided spring type and includes one spring piece 92 provided as a resilient contact piece in a case 90. A plate-like mating conductor 99 is inserted between a terminal conductor 91 and the spring piece 92, whereby the terminal conductor 91 and the mating conductor 99 are electrically connected.

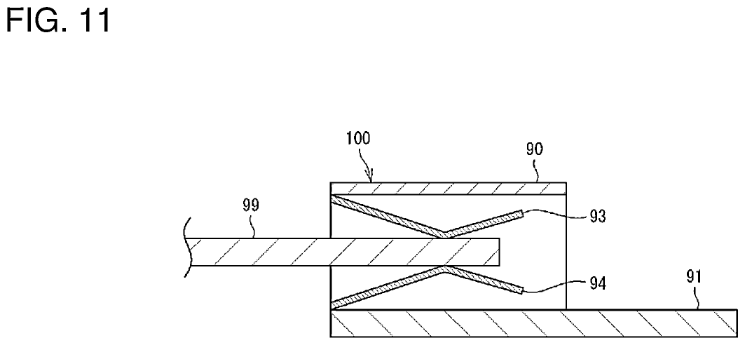

FIG. 11 is a section showing a schematic configuration of another conventional terminal. This terminal 100 is of a two-sided spring type and includes a pair of spring pieces 93, 94 provided as resilient contact pieces in a case 90. A plate-like mating conductor 99 is inserted between the pair of spring pieces 93 and 94, whereby a terminal conductor 91 and the mating conductor 99 are electrically connected via the spring pieces 93, 94.

In the case of the terminal 100 shown in FIG. 10, if the terminal 100 including the terminal conductor 91 is displaced downward, for example, in FIG. 10 by an external force such as vibration, a contact pressure between the terminal conductor 91 and the mating conductor 99 decreases and contact resistance increases.

In the case of the terminal 100 shown in FIG. 11, if the terminal 100 is displaced downward, for example, in FIG. 11, a contact pressure between the lower spring piece 94 and the mating conductor 99 decreases, but a contact pressure between the upper spring piece 93 and the mating conductor 99 increases. Thus, an increase of contact resistance due to a displacement as described above is reduced in the whole terminal 100.

However, in the case of the terminal 100 shown in FIG. 11, the spring pieces 93, 94 are in contact with the mating conductor 99 and thinner than the mating conductor 99 and the terminal conductor 91. Since the spring pieces 93, 94, which increase conductor resistance by being thin, are included in an electrically conductive path in the terminal 100, electrical resistance increases in the case of the terminal 100 shown in FIG. 11.

Accordingly, the present disclosure aims to suppress an increase in electrical resistance in a terminal to be connected to a mating conductor.

### Effect of Present Disclosure

According to the present disclosure, it is possible to suppress an increase in electrical resistance in a terminal to be connected to a mating conductor.

### Summary of Embodiments of Present Disclosure

Hereinafter, summaries of embodiments of the present disclosure are listed and described.

(1) The terminal of an embodiment is to be connected to a plate-like mating conductor inserted along a first direction, and provided with a case including a first wall located on one side in an orthogonal direction to the first direction, a second wall located on the other side in the orthogonal direction and coupling walls coupling the first and second walls, a first spring member including a first resilient piece, the first spring member being mounted on the first wall, a second spring member including a second resilient piece, the second spring member being mounted on the second wall, a plate-like first conductor thicker than the first resilient piece, the first conductor having a longitudinal direction along the first direction, and a plate-like second conductor thicker than the second resilient piece, the second conductor having a longitudinal direction along the first direction, the first conductor including a first connecting portion on one side in the longitudinal direction to be connected to another member and a first plate portion on the other side in the longitudinal direction, the second conductor including a second connecting portion on one side in the longitudinal direction to be connected to the other member and a second plate portion on the other side in the longitudinal direction, the first resilient piece biasing the first plate portion in a direction toward the second plate portion, the second resilient piece biasing the second plate portion in a direction toward the first plate portion, and a space between the first and second plate portions being a region where the mating conductor inserted along the first direction is sandwiched.

According to the terminal of this embodiment, the first plate portion of the first conductor and the second plate portion of the second conductor are directly in contact with the mating conductor. Since the first and second conductors are in the form of plates thicker than the first and second spring members, an increase in electrical resistance in the terminal can be suppressed. The first and second plate portions sandwich the mating conductor by biasing forces of the first and second resilient pieces. Even if the terminal and the mating conductor are relatively displaced in the orthogonal direction and, for example, a contact pressure between the second plate portion and the mating conductor decreases, a contact pressure between the first plate portion and the mating conductor on an opposite side is ensured. Thus, an increase in contact resistance is suppressed.

(2) Preferably, the first and second connecting portions are overlapped.

According to this configuration, the first and second connecting portions function like one thick electrically conductive plate and contributes to a reduction in electrical resistance.

(3) Preferably, the first spring member includes a plurality of the first resilient pieces, and the plurality of first resilient pieces are in contact with the first plate portion at a plurality of positions separated in the longitudinal direction.

According to this configuration, a relative high contact pressure acts at the plurality of positions separated in the longitudinal direction between the first plate portion and the mating conductor by the first spring member. This enhances resistance against relative rotations of the mating conductor and the first conductor about an axis along the orthogonal direction.

(4) Preferably, in the terminal of (3) described above, the first spring member includes a first seat portion to be fixed to the first wall and the plurality of first resilient pieces provided to extend from the first seat portion toward the first plate portion, and the plurality of first resilient pieces include a first leaf spring provided to extend in a direction opposite to the first direction from one part of the first seat portion located on a side of the first direction, the first leaf spring contacting a first target part of the first plate portion located on an opposite side in the first direction, and a second leaf spring provided to extend in the first direction from one part of the first seat portion located on a side of the direction opposite to the first direction, the second leaf spring contacting a second target part of the first plate portion located on the side of the first direction.

By this configuration, the first resilient pieces are in contact with the first plate portion at two positions separated in the longitudinal direction.

(5) Preferably, the second spring member includes a plurality of the second resilient pieces, and the plurality of second resilient pieces are in contact with the second plate portion at a plurality of positions separated in the longitudinal direction.

According to this configuration, a relative high contact pressure acts at the plurality of positions separated in the longitudinal direction between the second plate portion and the mating conductor by the second spring member. This enhances resistance against relative rotations of the mating conductor and the second conductor about an axis along the orthogonal direction.

(6) Preferably, a third spring member is further provided which contacts the mating conductor from a width direction orthogonal to both the first direction and the orthogonal direction.

According to this configuration, the mating conductor is sandwiched between the first and second conductors by the first and second spring members and supported by the third spring member from the width direction orthogonal to that sandwiching direction.

(7) An interval between the first and second plate portions facing each other is smaller than a thickness of the mating conductor in a resiliently deformed state by being biased by the first and second spring members.

More preferably, the interval between the first and second plate portions facing each other is smaller than the thickness of the mating conductor in a natural state. In this case, resilient deformation forces of the first and second plate portions can be applied to assist tightening for the mating conductor.

(8) Preferably, each of the first and second plate portions includes a plurality of protrusions capable of contacting the mating conductor, and the plurality of protrusions are provided side by side in a width direction orthogonal to both the first direction and the orthogonal direction.

In this case, even if the terminal and the mating conductor are twisted about an axial direction along the first direction and the contact pressures decrease on one side in the width direction on the respective first and second plate portions, the contact pressures on the other side are ensured.

### Details of Embodiments of Present Disclosure

Hereinafter, embodiments of the present disclosure are described in detail with reference to the drawings. Note that at least some of embodiments described below may be arbitrarily combined.

### [Concerning Overall Configuration of Terminal 10]

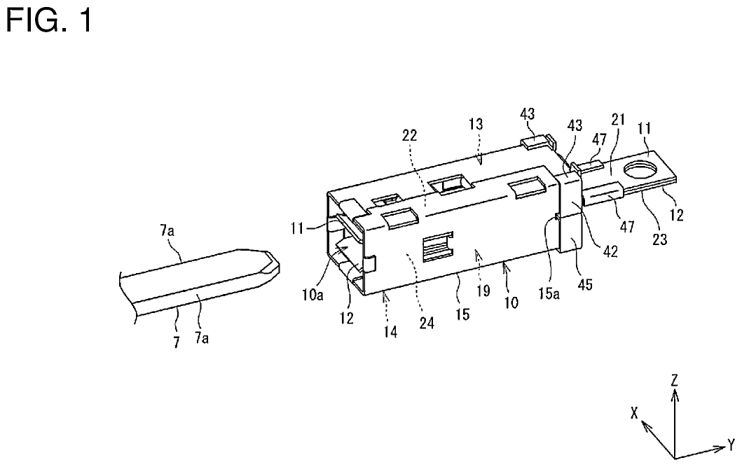

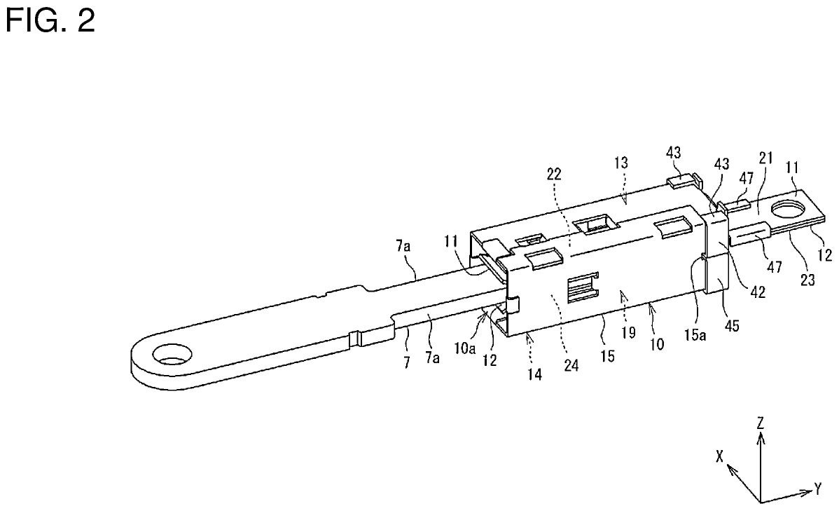

FIGS. 1 and 2 are perspective views of a terminal 10 of an embodiment. FIG. 1 shows a state before a mating conductor 7 is connected to the terminal 10, and FIG. 2 shows a state where the mating conductor 7 is connected to the terminal 10. The terminal 10 is used to connect unillustrated two electrical devices. A connector of one electrical device is provided with the terminal 10. A connector of the other electrical device includes the mating conductor 7. By connecting the mating conductor 7 to the terminal 10, the two electrical devices are connected. The electrical devices of this embodiment are in-vehicle devices of an automotive vehicle.

The terminal 10 is connected to the mating conductor 7 by inserting the mating conductor 7 along a first direction (linear direction from left to right in FIG. 1). The terminal 10 has a box shape having a longitudinal direction along the first direction. The first direction may be referred to as the “longitudinal direction” below. A side of an insertion opening 10a (left side in FIG. 1) for the mating conductor 7 in the longitudinal direction is referred to as an “opening side”. A side (right side in FIG. 1) opposite to the opening side in the longitudinal direction is referred to as a “back side”. In the terminal 10, a side of the first direction is the back side and an opposite side in the first direction is the opening side.

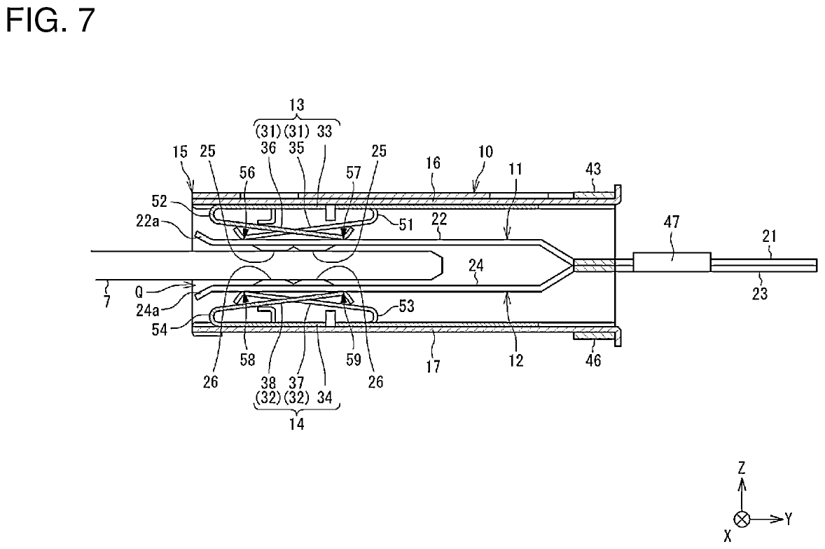

Although described later (see FIG. 7), the terminal 10 is connected to the mating conductor 7 in a sandwiching state. A sandwiching direction of the mating conductor 7 is a direction orthogonal to the longitudinal direction (first direction) and may be referred to as a “sandwiching direction” in the present disclosure. A direction orthogonal to both the longitudinal direction and the sandwiching direction is referred to as a “width direction”. XYZ orthogonal coordinates are shown in each figure. An X direction is the width direction (direction from one side toward the other side in the width direction), a Y direction is the longitudinal direction (direction from the opening side toward the back side) and a Z direction is the sandwiching direction.

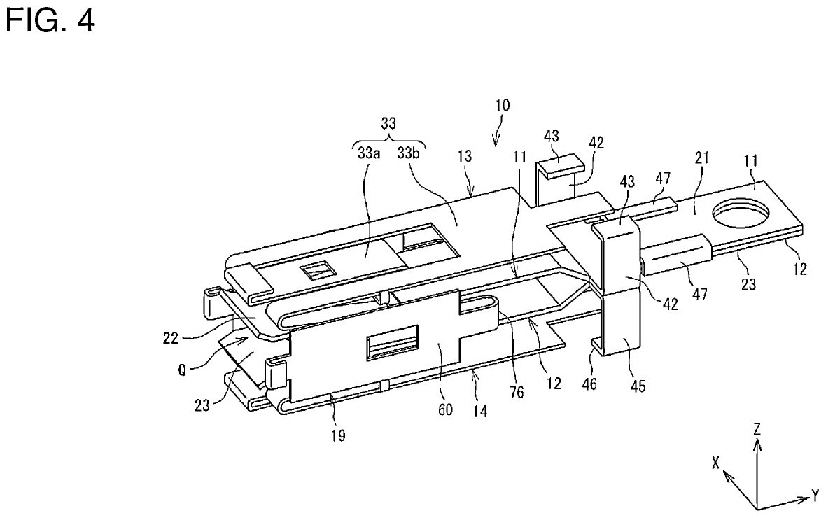

The mating conductor 7 is a plate-like electrically conductive member long in the Y direction and also referred to as a busbar (mating busbar). The mating conductor 7 has a rectangular cross-sectional shape. The mating conductor 7 is in the form of a plate wide in the X direction and thick in the Z direction. Specifically, the mating conductor 7 has a thickness (dimension in the Z direction) equal or larger than that of an overlapped part of a first conductor 11 and a second conductor 12 (see FIG. 4) to be described later (first connecting portion 21 and second connecting portion 23).

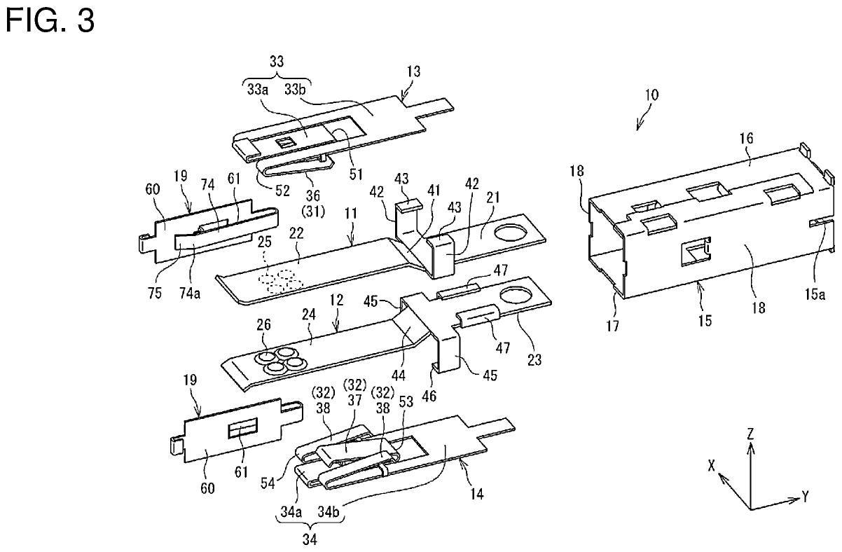

FIG. 3 is an exploded perspective view of the terminal 10 shown in FIG. 1. The terminal 10 of this embodiment is provided with one case 15, one first spring member 13, one second spring member 14, one first conductor 11 and one second conductor 12.

Further, the terminal 10 includes two third spring members 19, 19. FIG. 4 is a view showing an internal structure of the terminal 10 without the case 15.

### [Case 15]

As shown in FIG. 3, the case 15 has a tube shape long in the Y direction. The case 15 has a rectangular cross-sectional shape and includes a first wall 16 located on one side in the Z direction, a second wall 17 located on the other side in the Z direction and a pair of coupling walls 18 coupling the first and second walls 16, 17. The case 15 is made of metal and high in stiffness. The case 15 is not deformed even when receiving reaction forces from the first, second and third spring members 13, 14 and 19. The case 15 is formed with a plurality of cuts and openings to fix constituent members of the terminal 10 such as the first conductor 11.

### [First Conductor 11 and Second Conductor 12]

The first conductor 11 is a plate-like electrically conductive member long in the Y direction and also referred to as a busbar (first busbar). The first conductor 11 is thinner than the mating conductor 7 (see FIG. 1), but has a larger thickness and a larger transverse cross-sectional area than first resilient pieces 31 of the first spring member 13 to be described later. The first conductor 11 is constituted by an elongated metal piece, and bent at an intermediate part thereof. The first conductor 11 includes the first connecting portion 21 on one side in a longitudinal direction (back side), a first plate portion 22 on the other side in the longitudinal direction (opening side) and a first inclined portion 41 serving as the intermediate part linking the first connecting portion 21 and the first plate portion 22.

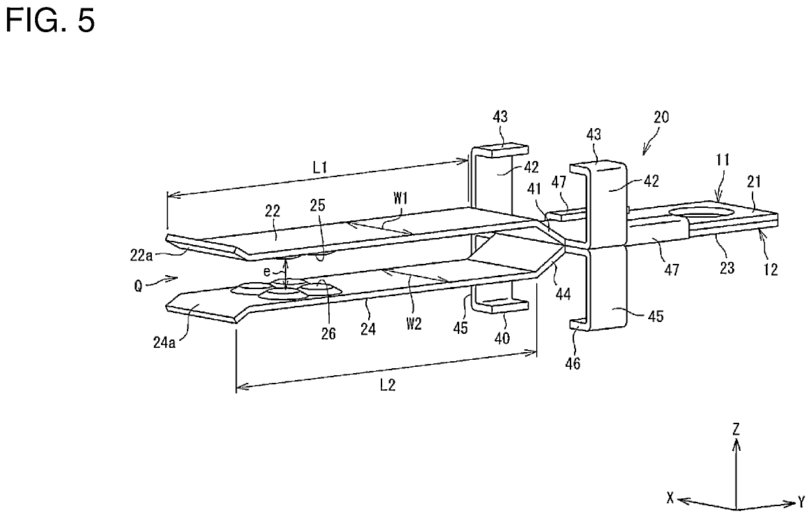

The first connecting portion 21 partially projects from the case 15 (see FIG. 1). The first connecting portion 21 has a linear shape in the Y direction. The first connecting portion 21 is overlapped on the second connecting portion 23 of the second conductor 12 (see FIG. 5). The first connecting portion 21 is electrically and mechanically connected to a device terminal (not shown) of the electrical device, which is a separate member, together with the second connecting portion 23. FIG. 5 is a perspective view of the terminal conductor 20 configured by integrating the first and second conductors 11, 12.

The first inclined portion 41 has an inclined shape extending toward one side in the Z direction from the first connecting portion 21 toward the first plate portion 22. That is, the first inclined portion 41 is shaped to be more separated from the second conductor 12 (second plate portion 24) from the first connecting portion 21 toward the first plate portion 22.

To fix the first conductor 11 to the case 15, the first connecting portion 21 includes a pair of first fixing arms 42, 42. The first fixing arm 42 is provided along the outer surface of the case 15 thought a cut 15a (see FIG. 3) provided in the case 15. The first fixing arm 42 includes a first claw portion 43 to be engaged with the first wall 16 of the case 15. By plastically deforming the tips of the first fixing arms 42 with the first conductor 11 mounted in the case 15 (see FIG. 1), the first claw portions 43 are formed. The tips are shown in a plastically deformed state in FIGS. 3 and 5. By this configuration, the first conductor 11 and the case 15 are integrated.

The first plate portion 22 is accommodated in the case 15 (see FIG. 1). The first plate portion 22 has a linear shape in the Y direction, and is directly brought into contact with and electrically connected to the mating conductor 7 inserted into the case 15. As described above, the first conductor 11 is fixed in the case 15. The first plate portion 22 is cantilevered to extend to the opening side via the first inclined portion 41 from fixing parts (fixing arms 42) to the case 15. In this embodiment, a length L1 (see FIG. 5) in the Y direction of the first plate portion 22 is more than three times as large as a width W1 in the X direction of the first plate portion 22, and the first plate portion 22 has an elongated strip shape. Thus, the first plate portion 22 is resiliently deformable in both directions along the Z direction with the side of the first connecting portion 21 as a fixed end.

As shown in FIG. 3, the second conductor 12 is a plate-like electrically conductive member long in the Y direction and also referred to as a busbar (second busbar). The second conductor 12 is thinner than the mating conductor 7 (see FIG. 1), but has a larger thickness and a larger transverse cross-sectional area than second resilient pieces 32 of the second spring member 14 to be described later. The second conductor 12 is constituted by an elongated metal piece, and bent at an intermediate part thereof. The second conductor 12 includes the second connecting portion 23 on one side in a longitudinal direction (back side), a second plate portion 24 on the other side in the longitudinal direction (opening side) and a second inclined portion 44 serving as the intermediate part linking the second connecting portion 23 and the second plate portion 24.

The second connecting portion 23 partially projects from the case 15 (see FIG. 1). The second connecting portion 23 has a linear shape in the Y direction. The second connecting portion 23 is overlapped on the first connecting portion 21 of the first conductor 11 (see FIG. 5). The second connecting portion 23 is electrically and mechanically connected to a device terminal (not shown) of the electrical device, which is a separate member, together with the first connecting portion 21.

The second inclined portion 44 has an inclined shape extending toward the other side in the Z direction from the second connecting portion 23 toward the second plate portion 24. That is, the second inclined portion 44 is shaped to be more separated from the first conductor 11 (first plate portion 22) from the second connecting portion 23 toward the second plate portion 24.

To fix the second conductor 12 to the case 15, the second connecting portion 23 includes a pair of second fixing arms 45, 45. The second fixing arm 45 is provided along the outer surface of the case 15 thought the cut 15a (see FIG. 3) provided in the case 15. The second fixing arm 45 includes a second claw portion 46 to be engaged with the second wall 17 of the case 15. By plastically deforming the tips of the second fixing arms 45 with the second conductor 12 mounted in the case 15 (see FIG. 1), the second claw portions 46 are formed. The tips are shown in a plastically deformed state in FIGS. 3 and 5. By this configuration, the second conductor 12 and the case 15 are integrated.

The second plate portion 24 is accommodated in the case 15 (see FIG. 1). The second plate portion 24 has a linear shape in the Y direction, and is directly brought into contact with and electrically connected to the mating conductor 7 inserted into the case 15. As described above, the second conductor 12 is fixed in the case 15. The second plate portion 24 is cantilevered to extend to the opening side via the second inclined portion 44 from fixing parts (fixing arms 45) to the case 15. In this embodiment, a length L2 (see FIG. 5) in the Y direction of the second plate portion 24 is more than three times as large as a width W2 in the X direction of the second plate portion 24, and the second plate portion 24 has an elongated strip shape. Thus, the second plate portion 24 is resiliently deformable in both directions along the Z direction with the side of the second connecting portion 23 as a fixed end.

The second conductor 12 includes crimping pieces 47, 47 on both sides in the width direction. The crimping pieces 47 integrate the first and second connecting portions 21, 23 in the overlapped state. The crimping pieces 47 are shown in a plastically deformed state in FIG. 3. Note that the first conductor 11 may include the crimping pieces 47. As shown in FIG. 5, the first and second connecting portions 21, 23 are overlapped. In this embodiment, the first and second connecting portions 21, 23 are joined by the crimping pieces 47. In contrast, the first and second plate portions 22, 24 are separated. A space between the first and second plate portions 22, 24 serves as a region Q where the mating conductor 7 inserted along the Y direction is sandwiched. The first and second conductors 11, 12 have the same shape except the crimping pieces 47, and are arranged in opposite orientations in the Z direction.

As shown in FIG. 3, the first plate portion 22 includes a plurality of first protrusions 25 capable of contacting the mating conductor 7. The first plate portion 22 of this embodiment includes four protrusions 25 in a region on a tip side thereof. Two protrusions 25, 25 are provided side by side in the X direction. Two protrusions 25, 25 arranged in the X direction are provided side by side in two rows in the Y direction. Two protrusions 25, 25 are preferably provided side by side in the X direction, but the number and arrangement of the protrusions 25 can be changed.

The second plate portion 24 includes a plurality of second protrusions 26 capable of contacting the mating conductor 7. The second plate portion 24 of this embodiment includes four protrusions 26 in a region on a tip side thereof. Two protrusions 26, 26 are provided side by side in the X direction. Two protrusions 26, 26 arranged in the X direction are provided side by side in two rows in the Y direction. Two protrusions 26, 26 are preferably provided side by side in the X direction, but the number and arrangement of the protrusions 26 can be changed.

### [First Spring Member 13]

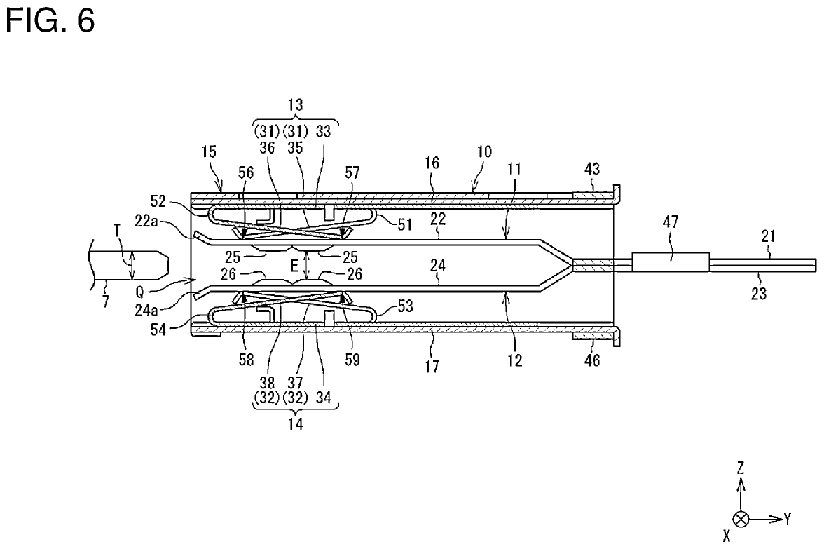

FIGS. 6 and 7 are sections of the terminal 10 when viewed along the X direction (width direction). FIG. 6 shows a state before the connection of the mating conductor 7, and FIG. 7 shows a state after the connection of the mating conductor 7. The first spring member 13 is mounted on the first wall 16 and integrated with the case 15. The first spring member 13 includes a first seat portion 33 to be fixed to the first wall 16 and the first resilient pieces 31 projecting toward the first plate portion 22 from the first seat portion 33.

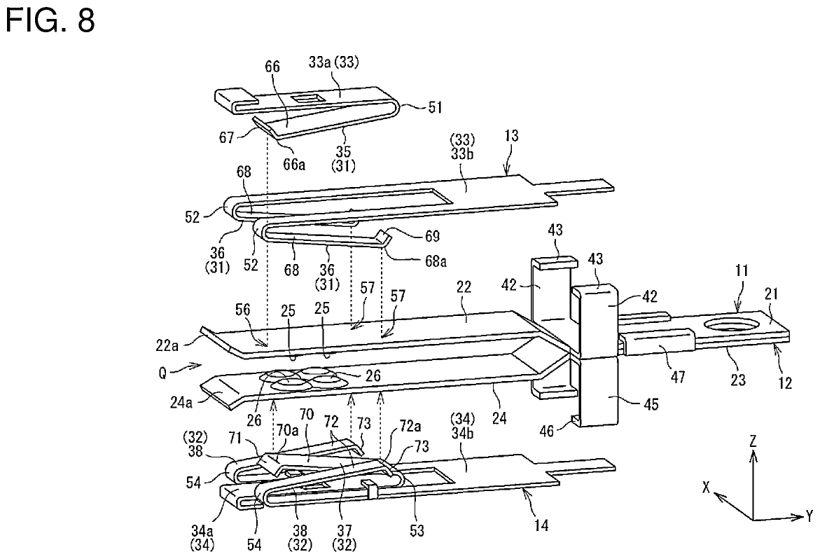

The first spring member 13 of this embodiment includes a plurality of the first resilient pieces 31. The plurality of first resilient pieces 31 include a first leaf spring 35 and second leaf springs 36. In accordance with this, as shown in FIG. 8, the first seat portion 33 is divided into a seat portion 33a for the first leaf spring 35 and a seat portion 33b for the second leaf springs 36, and these seat portions 33a, 33b are separate members. FIG. 8 is a view of the first spring member 13 and the second spring member 14, and the seat portions 33a, 33b are shown in a separated state in the first spring member 13. Note that the seat portions 33a, 33b may constitute one member even if the first spring member 13 includes the plurality of first resilient pieces 31.

The first resilient pieces 31 bias the first plate portion 22 in a direction toward the second plate portion 24. That is, each of the first and second leaf springs 35, 36 resiliently presses the first plate portion 22 in the direction toward the second plate portion 24. As just described, the first spring member 13 includes the first and second leaf springs 35, 36 as the plurality of first resilient pieces 31 provided to extend from the first seat portion 33 toward the first plate portion 22. In this embodiment, one first leaf spring 35 is provided in a center in the X direction. Two second leaf springs 36 are provided on both sides across the first leaf spring 35 in the X direction. Note that the arrangement of the first and second leaf springs 35, 36 may be reversed.

In FIGS. 6, 7 and 8, the first leaf spring 35 is provided to extend in a direction toward the opening side (leftward direction of each figure) from one part 51 located on the back side (right side of each figure) of the first seat portion 33. The first leaf spring 35 is in contact with a first target part 56 located on the opening side (left side of each figure) of the first plate portion 22. Each of the two second leaf springs 36 is provided to extend in a direction toward the back side (rightward direction of each figure) from one part 52 located on the opening side (left side of each figure) of the first seat portion 33. Each second leaf spring 36 is in contact with a second target part 57 located on the back side (right side of each figure) of the first plate portion 22.

As just described, the first resilient pieces 31 including one first leaf spring 35 and two second leaf springs 36 are in contact with the first plate portion 22 at two positions (first and second target parts 56 and 57) separated in the Y direction. The first and second leaf springs 35, 36 contact and resiliently press the first plate portion 22.

Further, the positions of the plurality of (four) protrusions 25 on a first surface of the first plate portion 22 and the positions of the first and second target parts 56, 57 on a second surface of the first plate portion 22 in the Y direction are described for the first plate portion 22. The plurality of (four) protrusions 25 are located between the first and second target parts 56, 57. Thus, biasing forces by the plurality of first resilient pieces 31 are applied to the plurality of protrusions 25 in a distributed manner, and each of the plurality of protrusions 25 can equally contact the mating conductor 7.

The shape of the first leaf spring 35 is further described. In FIG. 8, the first leaf spring 35 includes a first inclined spring portion 66 inclined to approach the first plate portion 22 from the one part 51 of the first seat portion 33 toward the opening side. The first leaf spring 35 further includes a first spring tip 67 inclined to be more separated from the first plate portion 22 from a tip part 66a of the first inclined spring portion 66 toward the opening side. A part (tip part 66a) between the first inclined spring portion 66 and the first spring tip 67 serves as a contact portion with the first target part 56 of the first plate portion 22.

The shape of the second leaf spring 36 is further described. The second leaf spring 36 includes a second inclined spring portion 68 inclined to approach the first plate portion 22 from the one part 52 of the first seat portion 33 toward the back side. The second leaf spring 36 further includes a second spring tip 69 inclined to be more separated from the first plate portion 22 from a tip part 68a of the second inclined spring portion 68 toward the back side. A part (tip part 68a) between the second inclined spring portion 68 and the second spring tip 69 serves as a contact portion with the second target part 57 of the first plate portion 22.

### [Second Spring Member 14]

The second spring member 14 has the same configuration as the first spring member and is provided in an opposite orientation in the Z direction in the case 15. As shown in FIGS. 6 and 7, The second spring member 14 is mounted on the second wall 17 and integrated with the case 15. The second spring member 14 includes a second seat portion 34 to be fixed to the second wall 17 and the second resilient pieces 32 projecting toward the second plate portion 24 from the second seat portion 34.

The second spring member 14 of this embodiment includes a plurality of the second resilient pieces 32. The plurality of second resilient pieces 32 include a third leaf spring 37 and fourth leaf springs 38. In accordance with this, the second seat portion 34 is divided into a seat portion 34a for the third leaf spring 37 and a seat portion 34b for the fourth leaf springs 38 and these seat portions 34a, 34b are separate members, similarly to the first spring member 13 (see FIG. 8). Note that the seat portions 34a, 34b may constitute one member even if the second spring member 14 includes the plurality of second resilient pieces 32.

The second resilient pieces 32 bias the second plate portion 24 in a direction toward the first plate portion 22. That is, each of the third and fourth leaf springs 37, 38 resiliently presses the second plate portion 24 in the direction toward the first plate portion 22. As just described, the second spring member 14 includes the third and fourth leaf springs 37, 38 as the plurality of second resilient pieces 32 provided to extend from the second seat portion 34 toward the second plate portion 24. In this embodiment, one third leaf spring 37 is provided in a center in the X direction. Two fourth leaf springs 38 are provided on both sides across the third leaf spring 37 in the X direction. Note that the arrangement of the second and second leaf springs 37, 38 may be reversed.

In FIGS. 6, 7 and 8, the third leaf spring 37 is provided to extend in a direction toward the opening side (leftward direction of each figure) from one part 53 located on the back side (right side of each figure) of the second seat portion 34. The third leaf spring 37 is in contact with a third target part 58 located on the opening side (left side of each figure) of the second plate portion 24. Each of the two fourth leaf springs 38, 38 is provided to extend in a direction toward the back side (rightward direction of each figure) from one part 54 located on the opening side (left side of each figure) of the second seat portion 34. Each fourth leaf spring 38 is in contact with a fourth target part 59 located on the back side (right side of each figure) of the second plate portion 24.

As just described, the second resilient pieces 32 including one third leaf spring 37 and two fourth leaf springs 38 are in contact with the second plate portion 24 at two positions (third and fourth target parts 58 and 59) separated in the Y direction. The third and fourth leaf springs 37, 38 contact and resiliently press the second plate portion 24.

Further, the positions of the plurality of (four) protrusions 26 on a first surface of the second plate portion 24 and the positions of the third and fourth target parts 58, 59 on a second surface of the second plate portion 24 in the Y direction are described for the second plate portion 24. The plurality of (four) protrusions 26 are located between the third and fourth target parts 58, 59. Thus, biasing forces by the plurality of second resilient pieces 32 are applied to the plurality of protrusions 26 in a distributed manner, and each of the plurality of protrusions 26 can equally contact the mating conductor 7.

The shape of the third leaf spring 37 is further described. In FIG. 8, the third leaf spring 37 includes a third inclined spring portion 70 inclined to approach the second plate portion 24 from the one part 53 of the second seat portion 34 toward the opening side. The third leaf spring 37 further includes a third spring tip 71 inclined to be more separated from the second plate portion 24 from a tip part 70a of the third inclined spring portion 70 toward the opening side. A part (tip part 70a) between the third inclined spring portion 70 and the third spring tip 71 serves as a contact portion with the third target part 58 of the second plate portion 24.

The shape of the fourth leaf spring 38 is further described. The fourth leaf spring 38 includes a fourth inclined spring portion 72 inclined to approach the second plate portion 24 from the one part 54 of the second seat portion 34 toward the back side. The fourth leaf spring 38 further includes a fourth spring tip 73 inclined to be more separated from the second plate portion 24 from a tip part 72a of the fourth inclined spring portion 72 toward the back side. A part (tip part 72a) between the fourth inclined spring portion 72 and the fourth spring tip 73 serves as a contact portion with the fourth target part 59 of the second plate portion 24.

### [Third Spring Members 19]

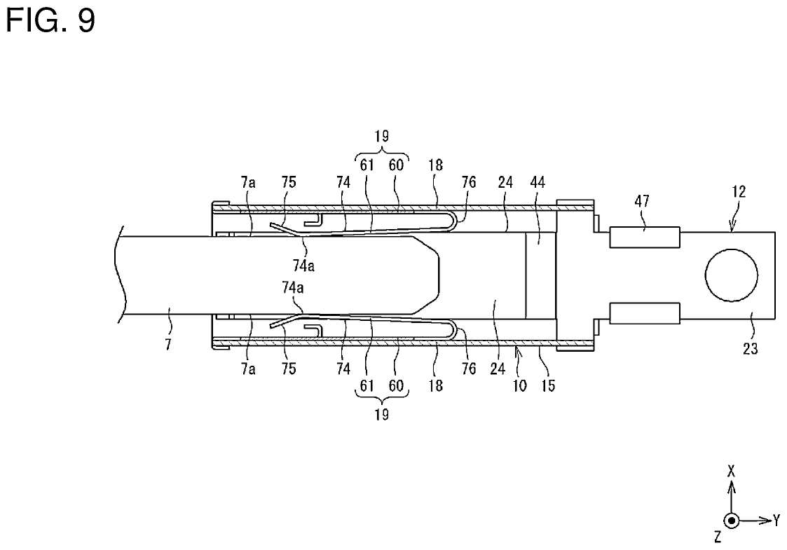

FIG. 9 is a section of the terminal 10 when viewed along the Z direction (sandwiching direction). The third spring members 19 are respectively mounted on the coupling walls 18, 18 provided on both widthwise sides of the case 15. A pair of the third spring members 19, 19 contact the mating conductor 7 inserted into the case 15 from the width direction. As shown in FIGS. 3 and 9, the third spring member 19 includes a third seat portion 60 to be fixed to the coupling wall 18 and a third resilient piece 61 projecting toward the mating conductor 7 from the third seat portion 60. The third resilient piece 61 is constituted by a leaf spring.

In a state before the mating conductor 7 is connected to the terminal 10, a minimum interval between one third resilient piece 61 and the other third resilient piece 61 is smaller than a widthwise dimension of the mating conductor 7. If the mating conductor 7 is connected to the terminal 10 (see FIG. 9), the third resilient pieces 61, 61 are pushed and resiliently deformed by the mating conductor 7, thereby pressing side surfaces 7a on both widthwise sides of the mating conductor 7 in parts with the minimum interval. The parts with the minimum interval serve as contact portions of the third spring member 19 with the mating conductor 7.

The shapes of the third resilient pieces 61 are further described. Note that the third spring members 19 on one and the other sides have the same shape. The third resilient piece 61 is provided to extend toward the opening side (leftward direction of FIG. 9) from one part 76 located on the back side (right side of FIG. 9) of the third seat portion 60. The third leaf spring 61 includes a fifth inclined spring portion 74 inclined to approach the mating conductor 7 from the one part 76 of the third seat portion 60 toward the opening side. The third resilient piece 61 further includes a fifth spring tip 75 inclined to be more separated from the mating conductor 7 from a tip part 74a of the fifth inclined spring portion 74 toward the opening side. A part (tip part 74a) between the fifth inclined spring portion 74 and the fifth spring tip 75 serves as the contact portion with the mating conductor 7.

Although not shown, recesses may be formed in both side parts in the width direction of the mating conductor 7. With the mating conductor 7 connected to the terminal 10, the tip parts 74a are fit into the recesses. By this fitting, a connected state of the mating conductor 7 to the terminal 10 can be detected (sensed), and a connection failure can be prevented. Further, a function of preventing the detachment of the mating conductor 7 from the terminal 10 is obtained by the above fitting.

### [Concerning Materials of Constituent Members of Terminal 10]

The first, second and third spring members 13, 14 and 19 are made of highly resilient metal, e.g. stainless steel for spring.

A material of the first and second conductors 11, 12 is different from and higher in electrical conductivity than that of the first and second spring members 13, 14 and the first and second conductors 11, 12 are, for example, made of copper alloy. The first and second conductors 11, 12 are also resilient.

The case 15 is preferably made of a metal material harder and having a higher elastic modulus than the first and second spring members 13, 14.

### [Connection of Mating Conductor 7 and Terminal 10]

As described above (see FIGS. 6 and 7), the space between the first and second plate portions 22, 24 is the region Q where the mating conductor 7 inserted along the Y direction is sandwiched. An interval E between the first and second plate portions 22, 24 facing each other is smaller than a thickness (dimension in the Z direction) T of the mating conductor 7 in a resiliently deformed state by being biased by the first and second spring members 13, 14. The thickness T is a dimension of a part to be sandwiched by the first and second plate portions 22, 24.

Note that the interval E is an interval between parts of the first and second plate portions 22, 24 contacting and sandwiching the mating conductor 7. The parts of the first and second plate portions 22, 24 contacting and sandwiching the mating conductor 7 are referred to as “sandwiching parts”. A minimum value of the interval E between the sandwiching parts is smaller than the thickness T of the mating conductor 7. In this embodiment, the first protrusions 25 are provided on the sandwiching part of the first plate portion 22, and the second protrusions 26 are provided on the sandwiching part of the second plate portion 24. Thus, the interval E (minimum part) is an interval between the first protrusions 25 of the first plate portion 22 and the second protrusions 26 of the second plate portion 24.

If the mating conductor 7 is connected to the terminal 10 (see FIG. 7), the first and second resilient pieces 31, 32 are pushed and resiliently deformed by the mating conductor 7 via the first and second plate portions 22, 24. Resilient deformation forces of the first and second resilient pieces 31, 32 are supported by the case 15 and the case 15 is not resiliently deformed. Thus, forces (reaction forces) caused by the resilient deformation of the first and second spring members 13, 14 can be applied as tightening forces for the mating conductor 7 via the first and second plate portions 22, 24.

In the resiliently deformed state, the interval E is smaller than the thickness T of the mating conductor 7. Further, in this embodiment, an interval between the first and second plate portions 22, 24 facing each other (minimum dimension between the sandwiching parts) e is smaller than the thickness T of the mating conductor 7 in a natural state where the first and second plate portions 22, 24 are not biased by the first and second spring members 13, 14 (see FIG. 5) before the assembly of the terminal 10. Thus, if the mating conductor 7 is connected to the terminal 10, the first and second plate portions 22, 24 are pushed and resiliently deformed by the mating conductor 7. As a result, forces (reaction forces) caused by the resilient deformation of the first and second plate portions 22, 24 can be applied to assist tightening of the mating conductor 7.

The first plate portion 22 includes a tip 22a inclined in a direction separating from the second plate portion 24 toward the opening side in an end part thereof. The second plate portion 24 includes a tip 24a inclined in a direction separating from the first plate portion 22 toward the opening side in an end part thereof. Thus, an interval between the tip 22a of the first plate portion 22 and the tip 24a of the second plate portion 24 is enlarged toward the opening side. A maximum value of the interval between the tips 22a and 24a is larger than the thickness T of the mating conductor 7. Thus, when the mating conductor 7 is connected to the terminal 10, the tip 22a of the first plate portion 22 and the tip 24a of the second plate portion 24 have a function of guiding the mating conductor 7 in the sandwiching direction.

Further, concerning the third spring members 19, 19 on the both widthwise sides, an interval between the fifth spring tip 75 of one third resilient piece 61 and the fifth spring tip 75 of the other third resilient piece 61 is enlarged from the tip parts 74a toward the opening side as shown in FIG. 9. Thus, the fifth spring tips 75 of the third spring members 19 have a function of guiding the mating conductor 7 in the width direction in connecting the mating conductor 7 to the terminal 10.

### [Concerning Terminal 10 of Embodiment]

The terminal 10 (see FIGS. 1 and 3) of this embodiment is electrically connected to the terminal 7 by inserting the plate-like mating conductor 7 along the Y direction. Thus, the terminal 10 is provided with the case 15, the first spring member 13, the second spring member 14, the plate-like first conductor 11 having the longitudinal direction along the Y direction, and the plate-like second conductor 12 having the longitudinal direction along the Y direction. The case 15 includes the first wall 16 located on the one side in the Z direction, the second wall 17 located on the other side in the Z direction and the pair of coupling walls 18, 18 coupling the first and second walls 16, 17. The first spring member 13 includes the first resilient pieces 31 and is mounted on the first wall 16. The second spring member 14 includes the second resilient pieces 32 and is mounted on the second wall 17. The first conductor 11 is thicker than the first resilient pieces 31, and the second conductor 12 is thicker than the second resilient pieces 32.

The first conductor 11 includes the first connecting portion 21 on the back side and the first plate portion 22 on the opening side. The second conductor 12 includes the second connecting portion 23 on the back side and the second plate portion 24 on the opening side. The first resilient pieces 31 bias the first plate portion 22 in the direction toward the second plate portion 24, and the second resilient pieces 32 bias the second plate portion 24 in the direction toward the first plate portion 22. The space between the first and second plate portions 22, 24 is the region Q where the mating conductor 7 inserted along the Y direction is sandwiched.

According to the terminal 10 of this embodiment, the first plate portion 22 of the first conductor 11 and the second plate portion 24 of the second conductor 12 are directly in contact with the mating conductor 7. Since the first and second conductors 11, 12 are in the form of thick plates, an increase in electrical resistance in the terminal 10 can be suppressed. The mating conductor 7 is sandwiched between the first and second plate portions 22, 24 by biasing forces of the first and second resilient pieces 31, 32. Even if the terminal 10 and the mating conductor 7 are relatively displaced in the Z direction and, for example, a contact pressure between the second plate portion 24 and the mating conductor 7 decreases, a contact pressure between the first plate portion 22 and the mating conductor 7 on an opposite side is ensured. Thus, an increase in contact resistance in the terminal 10 is suppressed.

Further, according to the terminal 10 of this embodiment, the first wall 16 of the case 15 receives a reaction force of the first spring member 13, and the second wall 17 of the case 15 receives a reaction force of the second spring member 14. Thus, the contact pressure between the first plate portion 22 and the mating conductor 7 given by the first spring member 13 hardly escapes, and the contact pressure between the second plate portion 24 and the mating conductor 7 given by the second spring member 14 hardly escapes, whereby an increase in contact resistance is suppressed. Since the mating conductor 7 is sandwiched from both sides by the first and second plate portions 22, 24, the number of contact points increases, contributing to a reduction in contact resistance. In this embodiment, the contact points are obtained on both surfaces on one and the other sides in the Z direction of the mating conductor 7 and, moreover, the contact points by the four first protrusions 25 are obtained on the one side and the contact points by the four second protrusions 26 are obtained on the other side. Contact resistance can be reduced by increasing the contact points.

Further, since being thin, the first and second resilient pieces 31, 32 are easily processed into desired shapes (spring shapes) for allowing these to function as leaf springs.

The first conductor 11, the second conductor 12, the first spring member 13 and the second spring member 14 are fixed to the case 15. Thus, at the time of connecting the mating conductor 7, the constituent members such as the first conductor 11 do not escape in the Y direction, wherefore a connecting operation is facilitated and a connected state is stabilized. The first conductor 11, the second conductor 12, the first spring member 13 and the second spring member 14 are members separate from the case 15. Thus, even if the shape of each constituent member is changed (adjusted), a degree of freedom is high and such a change or adjustment can be easily dealt with.

As shown in FIG. 5, the first and second connecting portions 21, 23 are overlapped. Thus, the first and second connecting portions 21, 23 function like one thick electrically conductive plate and contributes to a reduction in electrical resistance. If the first and second connecting portions 21, 23 are in surface contact, the crimping pieces 47 may be omitted and the first and second connecting portions 21, 23 may be merely stacked. Alternatively, the first and second connecting portions 21, 23 may be joined, for example, by ultrasonic bonding instead of by the crimping pieces 47.

As shown in FIGS. 6, 7 and 8, the first spring member 13 includes the plurality of first resilient pieces 31. The plurality of first resilient pieces 31 contact the first plate portion 22 at a plurality of positions separated in the Y direction. By this configuration, a relatively high contact pressure acts at the plurality of positions separated in the Y direction between the first plate portion 22 and the mating conductor 7 by the first spring member 13. This enhances resistance against relative rotations of the mating conductor 7 and the first conductor 11 (terminal 10) about an axis along the Z direction.

Specifically, the first spring member 13 is configured as follows. That is, the plurality of first resilient pieces 31 include the first and second leaf springs 35, 36. The first leaf spring 35 is provided to extend in the direction toward the opening side from the one part 51 located on the back side of the first seat portion 33 and contacts the first target part 56 located on the opening side of the first plate portion 22. The second leaf springs 36 are provided to extend in the direction toward the back side from the one part 52 located on the opening side of the first seat portion 33 and contact the second target part 57 located on the back side of the first plate portion 22.

Similarly to the first spring member 13, the second spring member 14 includes the plurality of second resilient pieces 32. The plurality of second resilient pieces 32 contact the second plate portion 24 at a plurality of positions separated in the Y direction. By this configuration, a relatively high contact pressure acts at the plurality of positions separated in the Y direction between the second plate portion 24 and the mating conductor 7 by the second spring member 14. This enhances resistance against relative rotations of the mating conductor 7 and the second conductor 12 (terminal 10) about an axis along the Z direction.

Specifically, the second spring member 14 is configured as follows. That is, the plurality of second resilient pieces 32 include the third and fourth leaf springs 37, 38. The third leaf spring 37 is provided to extend in the direction toward the opening side from the one part 53 located on the back side of the second seat portion 34 and contacts the third target part 58 located on the opening side of the second plate portion 24. The fourth leaf springs 38 are provided to extend in the direction toward the back side from the one part 54 located on the opening side of the second seat portion 34 and contact the fourth target part 59 located on the back side of the second plate portion 24.

As shown in FIG. 9, the terminal 10 includes the third spring members 19, 19 configured to contact the mating conductor 7 from the width direction. The mating conductor 7 is sandwiched between the first and second conductors 11, 12 by the first and second spring members 13, 14 and supported by the third spring members 19, 19 from the width direction orthogonal to the sandwiching direction. As a result, the mating conductor 7 is more stably connected in the terminal 10, and contact resistance between the mating conductor 7 and the first and second conductors 11, 12 can be stabilized.

As shown in FIG. 3, the first plate portion 22 includes the plurality of protrusions 25 capable of contacting the mating conductor 7 and, out of these, two protrusions 25, 25 are provided side by side in the X direction. The second plate portion 24 includes the plurality of protrusions 26 capable of contacting the mating conductor 7 and, out of these, two protrusions 26, 26 are provided side by side in the X direction. By this configuration, even if the terminal 10 and the mating conductor 7 are twisted about an axial direction along the Y direction and the contact pressures decrease on one side in the width direction on the respective first and second plate portions 22, 24, the contact pressures on the other side are ensured.

### Other Configurations

In this embodiment, there are a total of eight contact points with the mating conductor 7 including four points (four protrusions 25) on the side of the first conductor 11 and four points (four protrusions 26) on the side of the second conductor 12. The number of the contact points can be changed. For example, three contact points may be provided on the side of the first conductor 11, and three contact points may be provided on the side of the second conductor 12.

Although the contact points with the mating conductor 7 are symmetrical on the side of the first conductor 11 and on the side of the second conductor 12 in this embodiment, the contact points may be asymmetrically arranged.

The first spring member 13 may include one first resilient piece 31, and the second spring member 14 may include one second resilient piece 32.

The third spring members 19 are described with reference to FIG. 3. The third spring member 19 may include a supporting portion to be interposed between the first and second plate portions 22, 24. In the state before the mating conductor 7 is connected to the terminal 10, the supporting portions are in contact with the first and second plate portions 22, 24. In this way, the interval between the first and second plate portions 22, 24 is maintained. That is, the third spring members 19 prevents the region Q where the mating conductor 7 is sandwiched from being narrowed in the sandwiching direction.

The above embodiment is illustrative in all aspects, rather than restrictive. The scope of a right of the present invention is represented not by the above embodiment, but by claims and includes all changes in the scope of claims and in the meaning and scope of equivalents.

### LIST OF REFERENCE NUMERALS

7 mating conductor
7a side surface
10 terminal
11 first conductor
12 second conductor
13 first spring member
14 second spring member
15 case
15a cut
16 first wall
17 second wall
18 coupling wall
19 third spring member
20 terminal conductor
21 first connecting portion
22 first plate portion
22a tip
23 second connecting portion
24 second plate portion
24a tip
25 first protrusion
26 second protrusion
31 first resilient piece
32 second resilient piece
33 first seat portion
33a seat portion
33b seat portion
34 second seat portion
34a seat portion
34b seat portion
35 first leaf spring
36 second leaf spring
37 third leaf spring
38 fourth leaf spring
41 first inclined portion
42 first fixing arm
43 first claw portion
44 second inclined portion
45 second fixing arm
46 second claw portion
47 crimping piece
51 one part of first seat portion
52 one part of first seat portion
53 one part of second seat portion
54 one part of second seat portion
56 first target part
57 second target part
58 third target part
59 fourth target part
60 third seat portion
61 third resilient piece
66 first inclined spring portion
66a tip part
67 first spring tip
68 second inclined spring portion
68a tip part
69 second spring tip
70 third inclined spring portion
70a tip part
71 third spring tip
72 fourth inclined spring portion
72a tip part
73 fourth spring tip
74 fifth inclined spring portion
74a tip part
75 fifth spring tip
76 one part of third seat portion
E interval between first and second plate portions
L1 length in first direction of first plate portion
L2 length in first direction of second plate portion
Q region where mating conductor is sandwiched
T thickness of mating conductor 7
W1 dimension in width direction of first plate portion
W2 dimension in width direction of second plate portion

1. A terminal to be connected to a plate-like mating conductor inserted along a first direction, comprising:
a case including a first wall located on one side in an orthogonal direction to the first direction, a second wall located on the other side in the orthogonal direction and coupling walls coupling the first and second walls;
a first spring member including a first resilient piece, the first spring member being mounted on the first wall;
a second spring member including a second resilient piece, the second spring member being mounted on the second wall;
a plate-like first conductor thicker than the first resilient piece, the first conductor having a longitudinal direction along the first direction; and
a plate-like second conductor thicker than the second resilient piece, the second conductor having a longitudinal direction along the first direction,
the first conductor including a first connecting portion on one side in the longitudinal direction to be connected to another member and a first plate portion on the other side in the longitudinal direction,
the second conductor including a second connecting portion on one side in the longitudinal direction to be connected to the other member and a second plate portion on the other side in the longitudinal direction,
the first resilient piece biasing the first plate portion in a direction toward the second plate portion,
the second resilient piece biasing the second plate portion in a direction toward the first plate portion, and
a space between the first and second plate portions being a region where the mating conductor inserted along the first direction is sandwiched.

2. The terminal of claim 1, wherein the first and second connecting portions are overlapped.

3. The terminal of claim 1, wherein:
the first spring member includes a plurality of the first resilient pieces, and
the plurality of first resilient pieces are in contact with the first plate portion at a plurality of positions separated in the longitudinal direction.

4. The terminal of claim 3, wherein:
the first spring member includes a first seat portion to be fixed to the first wall and the plurality of first resilient pieces provided to extend from the first seat portion toward the first plate portion, and
the plurality of first resilient pieces include:
a first leaf spring provided to extend in a direction opposite to the first direction from one part of the first seat portion located on a side of the first direction, the first leaf spring contacting a first target part of the first plate portion located on an opposite side in the first direction; and
a second leaf spring provided to extend in the first direction from one part of the first seat portion located on a side of the direction opposite to the first direction, the second leaf spring contacting a second target part of the first plate portion located on the side of the first direction.

5. The terminal of claim 3, wherein:
the second spring member includes a plurality of the second resilient pieces, and
the plurality of second resilient pieces are in contact with the second plate portion at a plurality of positions separated in the longitudinal direction.

6. The terminal of claim 1, further comprising a third spring member configured to contact the mating conductor from a width direction orthogonal to both the first direction and the orthogonal direction.

7. The terminal of claim 1, wherein an interval between the first and second plate portions facing each other is smaller than a thickness of the mating conductor in a natural state.

8. The terminal of claim 1, wherein:
each of the first and second plate portions includes a plurality of protrusions capable of contacting the mating conductor, and
the plurality of protrusions are provided side by side in a width direction orthogonal to both the first direction and the orthogonal direction.
